(19) United States
(12) Patent Application Publication
(10) Pub. No.: US 2026/0188004 A1
(43) Pub. Date: Jul. 2, 2026

(54) DEVICE AND METHOD FOR PROVIDING AUGMENTED REALITY IMAGE THROUGH REAL-TIME MERGING OF DRONE IMAGE AND VIRTUAL OBJECT

(71) Applicants: Jae Heon JUNG, Seoul (KR); Yu Mi LEE, Incheon (KR); SLZ Inc., Siheung-si (KR)

(72) Inventors: Jae Heon JUNG, Seoul (KR); Yu Mi LEE, Incheon (KR); Bong Sang KIM, Siheung-si (KR)

(73) Assignees: Jae Heon JUNG, Seoul (KR); Yu Mi LEE, Incheon (KR); SLZ Inc., Siheung-si (KR)

(21) Appl. No.: 19/436,007

(22) Filed: Dec. 30, 2025

(30) Foreign Application Priority Data
Dec. 30, 2024 (KR) 10-2024-0199558
Feb. 28, 2025 (KR) 10-2025-0026369

(51) Int. Cl. G06V 20/20; G05D 1/24; G05D 109/20; G05D 111/10; G06V 10/75; G06V 10/82; G06V 20/17

(52) U.S. Cl. CPC G06V 20/20; G05D 1/24; G06V 10/751; G06V 10/82; G06V 20/17; G05D 2109/20; G05D 2111/10

(57) ABSTRACT

Provided is a device including a communication module that receives a drone image from a drone, and a processor that generates an AR image by merging the virtual object in virtual space with the drone image. The processor converts first location information of the drone in real space into second location information in virtual space, generates the AR image based on a field of view (FOV) of a virtual camera positioned at a location corresponding to the second location information in the virtual space, calculates a similarity between the AR image and the drone image, and corrects the second location information when the calculated similarity is lower than a predetermined similarity.

### CROSS-REFERENCE TO RELATED APPLICATIONS

A claim for priority under 35 U.S.C. § 119 is made to Korean Patent Application No. 10-2024-0199558 filed on Dec. 30, 2024 and 10-2025-0026369 filed on Feb. 28, 2025 in the Korean Intellectual Property Office, the entire contents of which are hereby incorporated by reference.

### BACKGROUND

Embodiments of the present disclosure described herein relate to a device and a method for providing augmented reality (AR) images, and more particularly, relate to a device and a method for providing AR images through real-time merging of drone images and virtual objects.

Virtual Reality (VR) technology provides real-world objects or backgrounds as Computer Graphic (CG) images. Augmented Reality (AR) technology provides virtual CG images over real-world object images. Mixed Reality (MR) technology is a computer graphics technology that mixes and combines virtual objects in the real world. The aforementioned VR, AR, and MR technologies are collectively referred to as extended Reality (XR) technology.

Nowadays, Artificial intelligence (AI) and AR technologies have been applied in various fields, and efforts are being made to apply these technologies to construction sites. For example, it is expected that XR content may be created by using Building Information Modeling (BIM) design data to perform design changes, and supervision at construction sites.

However, when the XR content is created by using the BIM design data, there is a limit to the alignment of the field of view of an actual image and the field of view of a virtual camera, thereby reducing the accuracy and stability of the XR content.

### SUMMARY

Embodiments of the present disclosure provide a device and a method for providing AR images that acquires GNSS/GPS information of a drone or humanoid robot in real space and tracks and corrects the location of a virtual camera in virtual space in real time.

Problems to be solved by the present disclosure are not limited to the problems mentioned above, and other problems not mentioned will be apparent by those skilled in the art from the following description.

According to an embodiment, a device includes a communication module that receives a drone image from a drone, and a processor that generates an AR image by merging the virtual object in virtual space with the drone image. The processor converts first location information of the drone in real space into second location information in the virtual space, generates the AR image based on a field of view (FOV) of a virtual camera positioned at a location corresponding to the second location information in the virtual space, calculates a similarity between the AR image and the drone image, and corrects the second location information when the calculated similarity is lower than a predetermined similarity.

In the meantime, the processor may obtain predetermined flight path information of the drone, and may correct the second location information by using the flight path information.

Moreover, the processor may generate a dataset including a plurality of drone images captured while the drone flies based on the flight path information, may extract a drone image, which has a highest similarity to the AR image, from among the plurality of drone images included in the dataset, and may correct the second location information by using location information corresponding to a location where the extracted drone image is captured.

Furthermore, the processor may include an Artificial intelligence (AI) model that learns the dataset and outputs location information corresponding to an input image, may obtain an output value by inputting the AR image to the AI model, and may correct the second location information by using the output value of the AI model.

In addition, the location information may include at least one of a latitude, a longitude, an altitude, and a rotation value.

Besides, the processor may generate the AR image by synthesizing the virtual object with a real object in the real space, which is included in the drone image.

Also, the processor may include a Deep Object Pose Estimation (DOPE) learning model that learns a plurality of images, which are obtained by capturing the real object, and outputs a vector from a camera to a center point of the real object included in an input image, may calculate the vector from the camera mounted on the drone to the center point of the real object included in the drone image by inputting the drone image to the DOPE learning model, and may correct the second location information by using the calculated vector.

Moreover, the processor may calculate a first center point by applying the calculated vector to the second location information, may calculate a predetermined second center point to place the virtual object in the virtual space, and may correct the second location information by using a difference between the first center point and the second center point.

Furthermore, the processor may calculate the similarity by comparing a pixel value of the AR image and a pixel value of the drone image, or may extract at least one feature point from each of the AR image and the drone image, and calculate the similarity by comparing the extracted feature point.

According to an embodiment, an AR image providing method performed by an AR image providing device includes receiving a drone image from a drone, converting first location information of the drone in real space into second location information in virtual space, placing a virtual camera at a location corresponding to the second location information in the virtual space, generating an AR image obtained by merging a virtual object in the virtual space with the drone image based on a FOV of the virtual camera, calculating a similarity between the AR image and the drone image, and correcting the second location information when the calculated similarity is lower than a predetermined similarity.

Besides, a computer program stored in a computer-readable recording medium for execution to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual diagram of an AR image providing system, according to an embodiment of the present disclosure;

FIGS. 2 to 4 are examples of user screens provided by a system, according to an embodiment of the present disclosure;

FIG. 5 is an example of a drone controller, according to an embodiment of the present disclosure;

FIG. 6 is a control block diagram of the device illustrated in FIG. 1;

FIG. 7 is a flowchart of an AR image providing method, according to an embodiment of the present disclosure; and

FIGS. 8 to 11 are detailed flowcharts of operation S600 illustrated in FIG. 7.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, a ‘device according to an embodiment of the present disclosure’ includes all various devices capable of providing results to a user by performing arithmetic processing. For example, the device according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Functions related to artificial intelligence according to an embodiment of the present disclosure are operated through a processor and a memory. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

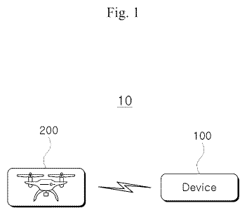

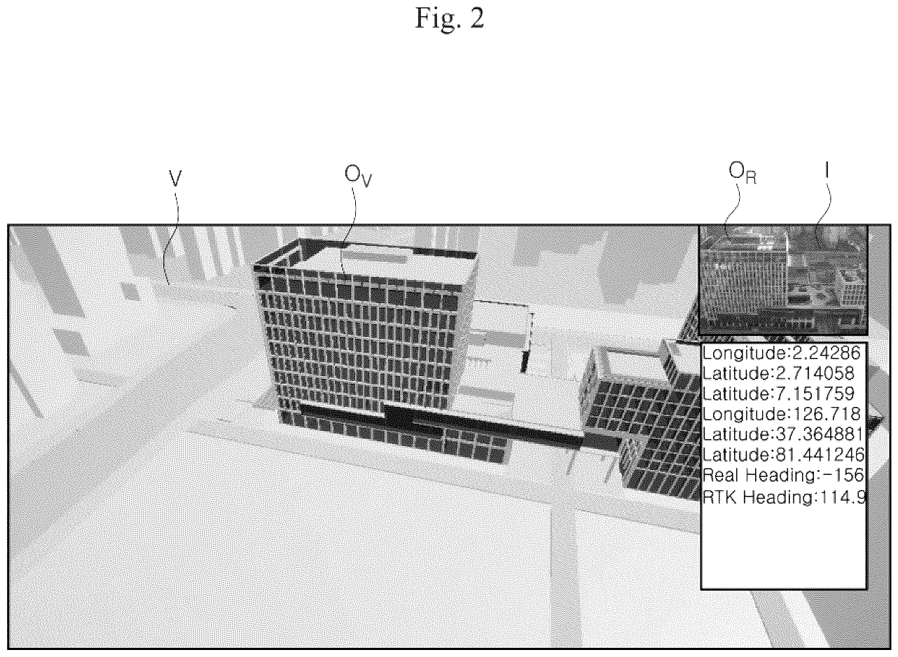

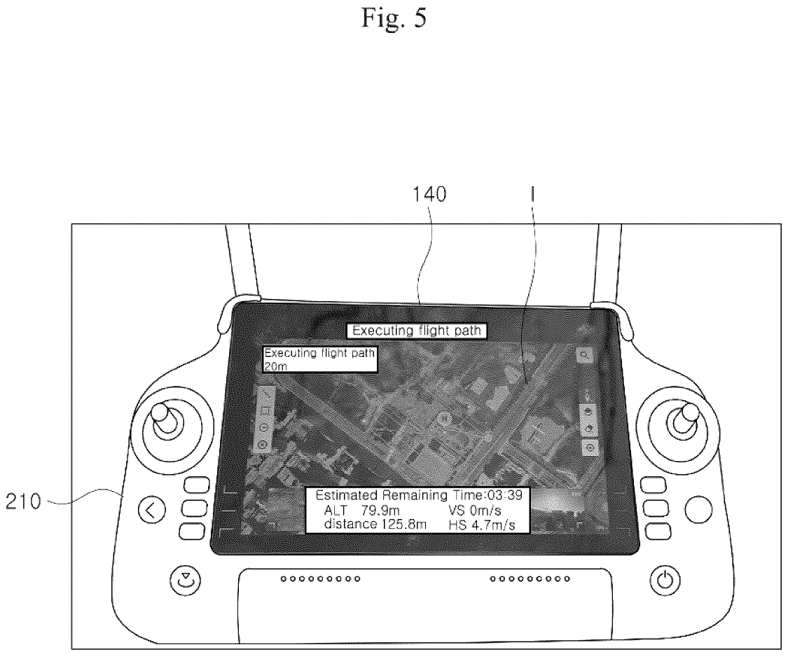

FIG. 1 is a conceptual diagram of an AR image providing system, according to an embodiment of the present disclosure. FIGS. 2 to 4 are diagrams illustrating examples of user screens provided by a system, according to an embodiment of the present disclosure. FIG. 5 is a diagram illustrating an example of a drone controller, according to an embodiment of the present disclosure.

Referring to FIG. 1, a system 10 according to an embodiment of the present disclosure may include a device 100 and a drone 200.

The device 100 may provide an AR image providing service according to an embodiment of the present disclosure.

The AR image providing service according to an embodiment of the present disclosure may provide an AR image by merging a virtual object in a virtual space with an image in a real space in real time. In this case, a stable AR image may be provided by correcting the distance between a virtual camera and a virtual object in the virtual space in real time.

The AR image providing service according to an embodiment of the present disclosure may apply AR to images in real space acquired by using a camera mounted on a drone or a humanoid robot, thereby overcoming the limitations of spatial constraints in providing AR images operated at a conventional human scale. Moreover, virtual objects in the virtual space may be BIM data, may be 3D models of civil structures and buildings, and may be variously applied to safety and disaster prevention fields, construction fields such as civil engineering, construction, and shipbuilding, and disaster management fields.

For example, referring to FIG. 2, the device 100 may obtain an image ‘I’ in real space. The image ‘I’ in real space may be an image captured of at least one real object O_{R}. The device 100 may create an AR image by merging a virtual object O_{V} implemented in a virtual space ‘V’ with the location of the real object O_{R} in the image ‘I’ in real space.

In this case, the device 100 may obtain real-time GNSS/GPS information about the image ‘I’ in the real space, may track the augmented location to place the virtual object O_{V}, and may align the image ‘I’ in the real space with the Field Of View (FOV) of the virtual space ‘V’.

In the meantime, in the following description, it is described that the image ‘I’ in the real space is a drone image acquired through a camera mounted on the drone 200, as an example. Furthermore, it is described that a virtual object is a 3D model included in BIM data. However, the scope of the present disclosure is not limited thereto. For example, the image ‘I’ in the real space may be an image acquired through a remotely controllable camera, or an image directly captured by a user. The virtual object may be a 3D model representing a building, a character model, a natural object, or mechanical equipment in virtual space.

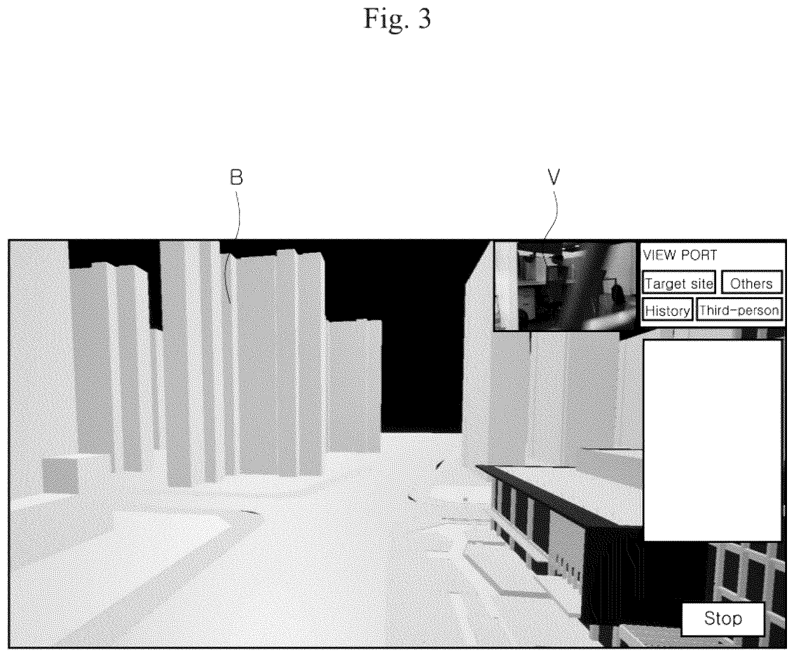

For example, referring to FIG. 3, the device 100 may output a user screen that provides gimbal control information for a camera mounted on the drone 200. As illustrated in FIG. 3, the user screen may provide BIM data “B” and a viewer ‘V’ based on the gimbal control information. A user may adjust the synchronization between the BIM data “B” and the camera mounted on the drone 200.

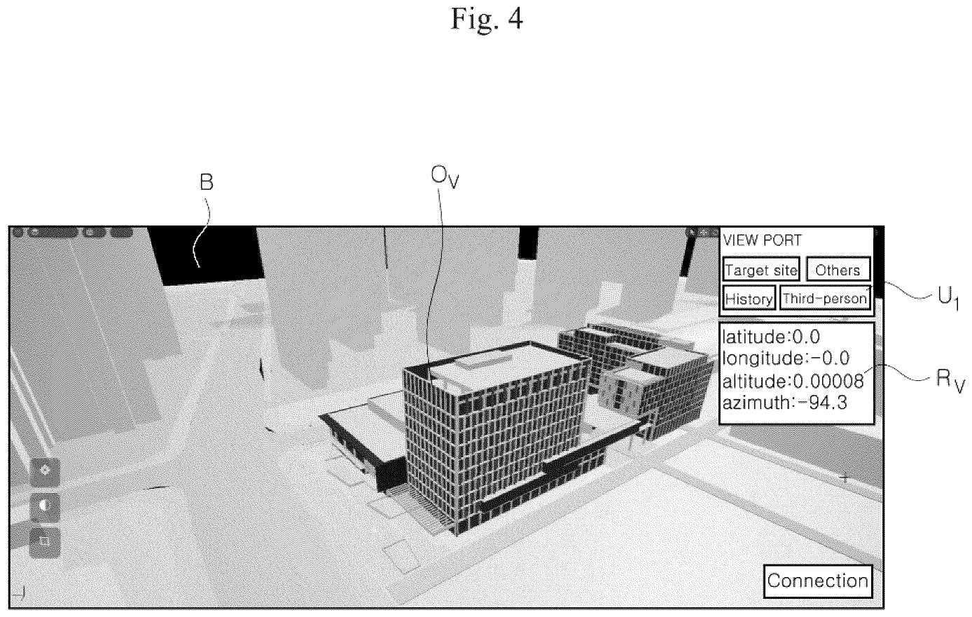

Besides, referring to FIG. 4, the device 100 may output the user screen that provides the BIM data “B”. As illustrated in FIG. 4, a 3D model included in the BIM data may be provided as the virtual object O_{V}, and its location information R_{V} may be provided. Also, the device 100 may provide a selection screen U₁ for controlling a viewpoint of the AR image through the user screen.

The drone 200 may refer to an unmanned device that operates remotely through wireless control, or an unmanned device that performs a specified unmanned mission through an autonomous operation system, and may operate in the air, on land, in the water, and underwater.

The drone 200 may include an image device and a communication device.

For example, the drone 200 may include at least one of a thermal imaging camera and a PTZ camera as one of its image devices, and may include a wireless communication module as one of its communication devices.

The drone 200 may acquire drone images by using an image device and may transmit the drone images to the device 100 by using a communication device.

In the meantime, the drone 200 may be controlled to receive a flight path from the device 100 and to fly along a flight path. Moreover, the drone 200 may provide the device 100 with GPS/GNSS-based real-time location information, Inertial Measurement Unit (IMU)-based rotation information, and the like.

Meanwhile, referring to FIG. 5, the drone 200 may further include a drone controller 210. The drone controller 210 may display at least one of six-axis movement control information of the drone 200, movement information of a camera gimbal, and an virtual object through a display 140, and may display the real-time drone image ‘I’ such that the user is capable of obtaining an image at a desired point in time.

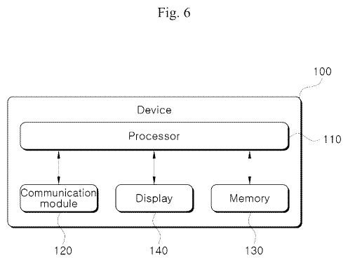

The system 10 according to an embodiment of the present disclosure may overcome spatial limitations by generating and providing an AR image based on a drone image. Furthermore, the system 10 may provide a stable AR image by correcting the distance between a virtual object and a virtual camera in virtual space in real time. FIG. 6 is a control block diagram of the device illustrated in FIG. 1.

Referring to FIG. 6, the device 100 according to an embodiment of the present disclosure may include a processor 110, a communication module 120, a memory 130, and the display 140.

The components shown in FIG. 6 are not essential in implementing the device 100. The device 100 described herein may have more or fewer components than those listed above.

The processor 110 may perform a process for providing an AR image service according to an embodiment of the present disclosure.

The processor 110 may be implemented with a memory that stores data regarding an algorithm for controlling operations of components within the present device 100, or a program for realizing the algorithm, and the at least one processor that performs the above-described operation by using data stored in the memory. At this time, the memory and the processor may be implemented as separate chips. Alternatively, the memory and the processor may be implemented as a single chip.

Furthermore, to implement various embodiments of the present disclosure described below in the drawing, the processor 110 may control one of the components described above or the combination of the components.

For example, the processor 110 may receive a drone image from the drone 200 via the communication module 120 and may generate an AR image by merging the drone image with a virtual object in virtual space.

The processor 110 may convert first location information of the drone in real space into second location information in virtual space, may generate an AR image based on a field of view of a virtual camera positioned at a location corresponding to the second location information in the virtual space, may calculate a similarity between the AR image and the drone image, and may correct the second location information when the calculated similarity is lower than a predetermined similarity.

Moreover, the processor 110 may obtain predetermined flight path information of the drone, and may correct the second location information by using the flight path information.

Moreover, the processor 110 may generate a dataset including a plurality of drone images captured while the drone flies based on the flight path information, may extract a drone image, which has a highest similarity to the AR image, from among the plurality of drone images included in the dataset, and may correct the second location information by using location information corresponding to a location where the extracted drone image is captured.

Furthermore, the processor 110 may include an artificial intelligence (AI) model that learns the dataset and outputs location information corresponding to an input image, may obtain an output value by inputting the AR image to the AI model, and may correct the second location information by using the output value of the AI model.

In addition, the location information may include at least one of a latitude, a longitude, an altitude, and a rotation value.

Besides, the processor 110 may generate the AR image by synthesizing the virtual object with a real object in the real space, which is included in the drone image.

Also, the processor 110 may include a Deep Object Pose Estimation (DOPE) learning model that learns a plurality of images, which are obtained by capturing the real object, and outputs a vector from a camera to a center point of the real object included in an input image, may calculate the vector from the camera mounted on the drone to the center point of the real object included in the drone image by inputting the drone image to the DOPE learning model, and may correct the second location information by using the calculated vector.

Moreover, the processor 110 may calculate a first center point by applying the calculated vector to the second location information, may calculate a predetermined second center point to place the virtual object in the virtual space, and may correct the second location information by using a difference between the first center point and the second center point.

Furthermore, the processor 110 may calculate the similarity by comparing a pixel value of the AR image and a pixel value of the drone image, or may extract at least one feature point from each of the AR image and the drone image, and calculate the similarity by comparing the extracted feature point.

The communication module 120 may include one or more components capable of communicating with an external device, and may include, for example, at least one of a wired communication module, a wireless communication module, a short-range communication module, and a location information module.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard232 (RS-232), power line communication, or plain old telephone service (POTS).

Here, the wireless communication module may include a wireless communication module for supporting various wireless communication methods such as Global System for Mobile (GSM) communication, Code Division Multiple Access (CDMA), Wideband Code Division Multiple Access (WCDMA), Universal Mobile Telecommunication System (UMTS), Time Division Multiple Access (TDMA), Long Term Evolution (LTE), 4G, 5G, and 6G in addition to a Wi-Fi module and Wireless broadband module.

The wireless communication module may include a wireless communication interface including an antenna and a transmitter that transmit mobile communication signals. Moreover, the wireless communication module may further include a signal conversion module that modulates a digital control signal, which is output from the processor 110 through a wireless communication interface, into an analog wireless signal under the control of the processor 110.

The short-range communication module may be used for short range communication, and may support short-range communication by using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB) technologies.

The location information module is a module for obtaining a location (or current location) of the device according to an embodiment of the present disclosure, and representative examples thereof include a Global Positioning System (GPS) module or a Wireless Fidelity (Wi-Fi) module. For example, when the GPS module is utilized, the location of the present device may be obtained by using signals sent from GPS satellites. For another example, when the Wi-Fi module is utilized, the location of this device may be obtained based on information from the Wi-Fi module and the wireless Access Point (AP) that transmits or receives wireless signals. As required, the location information module may perform a function of any other module of the communication unit to obtain data associated with the location of the present device, alternatively or additionally. The location information module is a module used to obtain the location (or current location) of the present device, and is not limited to a module that directly calculates or obtains the location of the present device.

The memory 130 may store data that supports various functions of the present device, and a program for operations of the processor 110, may store input/output data, and may store a plurality of application programs (or applications) running on the present device, pieces of data for operations of the present device, and instructions. At least part of the application programs may be downloaded from an external server through wireless communication.

The memory 130 may include the type of a storage medium of at least one of a flash memory type, hard disk type, a solid state disk (SSD) type, a silicon disk drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory 130 may be separate from the present device, but may be a database connected by wire or wirelessly.

The display 140 displays (outputs) information processed by the present device 100. For example, the display 140 may display execution screen information of an application program (e.g., an application) running on the present device 100, or a user interface (UI) or graphical user interface (GUI) information according to such the execution screen information.

At least one component may be added or deleted to correspond to the performance of the components illustrated in FIG. 6. Furthermore, it will be easily understood by those skilled in the art that mutual locations of the components may be changed to correspond to the performance or structure of the system.

In the meantime, each component shown in FIG. 6 refers to software components and/or hardware components such as field programmable gate array (FPGA) and application specific integrated circuit (ASIC).

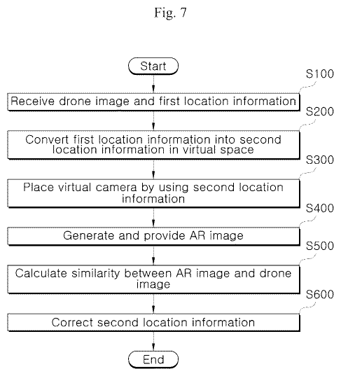

FIG. 7 is a flowchart of an AR image providing method, according to an embodiment of the present disclosure.

A method for providing an AR image according to an embodiment of the present disclosure may be performed by the device 100 illustrated in FIG. 6. Referring to FIG. 7, the method may include operation S100 of, by the processor 110, receiving a drone image and first location information, operation S200 of converting the first location information into second location information in virtual space, operation S300 of placing a virtual camera by using the second location information, operation S400 of generating and providing an AR image, operation S500 of calculating a similarity between the AR image and the drone image, and operation S600 of correcting the second location information.

The processor 110 may receive a drone image and first location information from the drone 200 via the communication module 120 (S100).

For example, the drone image may be an image of a real object captured in real space.

The first location information is location information of the drone 200 in real space, and may include, for example, at least one of a latitude, a longitude, an altitude, and a rotation value.

In the meantime, the processor 110 may generate flight path information of the drone 200 and may transmit the flight path information to the drone 200 via the communication module 120. Alternatively, the processor 110 may receive the flight path information from an external server and may provide the flight path information to the drone 200. The drone 200 may acquire drone images while flying based on the predetermined flight path information.

The processor 110 may convert first location information in real space into second location information in virtual space (S200).

For example, the coordinate system in real space may be applied as a world coordinate system or a geographic coordinate system and may be defined as a latitude, a longitude, and an altitude. The coordinate system in virtual space may be applied as a 3D virtual coordinate system and may be defined by the X, Y, and Z axes. The processor 110 may convert the first location information in real space into the second location information in virtual space by using a transformation matrix.

The processor 110 may place a virtual camera at a location corresponding to the second location information in virtual space (S300) and may generate and provide an AR image by calculating a field of view (FOV) set by the virtual camera (S400).

For example, the processor 110 may set a sensor size including a sensor height and a sensor width of the virtual camera. The processor 110 may obtain a Diagonal Field of View (DFOV), which is an angle value relative to the reference diagonal of the drone image, may calculate a distance from the center of the virtual camera's lens to an image plane by using the DFOV and the sensor size of the virtual camera, and may calculate the FOV of the virtual camera by using the distance from the center of the lens to the image plane. Equation 1 below is an example of a mathematical expression for calculating the distance from the center of the lens to the image plane. Equation 2 below is an example of a mathematical expression for calculating the FOV of the virtual camera.

$$Lens Center To Image Plane = \frac{\sqrt{{Sensor\_Height}^{2} + {Sensor\_Width}^{2}}}{2 \cdot tan ( \frac{DFOV}{2} )} \qquad [ Equation 1 ]$$

$$HFOV = {tan}^{- 1} ( \frac{Sensor\_Width}{2 \cdot Lens Center To Image Plane} ) \times 2 \qquad [ Equation 2 ]$$

In Equations 1 and 2, the DFOV represents an angle value relative to the reference diagonal of the drone image; a Horizontal Field of View (HFOV) represents the FOV of the virtual camera; and a sensor height and a sensor width represent the size of the virtual camera sensor.

The processor 110 may generate an AR image based on the FOV of the virtual camera calculated at a location corresponding to the second location information in virtual space.

For example, the processor 110 may place a virtual camera at the location corresponding to the second location information in the virtual space and may render the virtual space based on the FOV of the virtual camera. In this case, the background of the virtual space may be the drone image, and the virtual object will be placed at a predetermined location in the virtual space.

The processor 110 may provide the AR image to the user's mobile terminal or may provide it through an output module (not shown).

The processor 110 may calculate the similarity between the AR image and the drone image (S500).

For example, the processor 110 may calculate the similarity between the AR image and the drone image by using at least one of feature values and pixel values of the AR image and the drone image.

The processor 110 may calculate the mean squared error (MSE) value between each pixel of the AR image and the drone image as the similarity. In this case, as the value is smaller, the similarity may be considered to be higher. Alternatively, to measure the structural similarity between the AR image and the drone image, the processor 110 may calculate a structural similarity index (SSIM) value using the mean value and variance of each pixel as the similarity. In this case, as a value is closer to 1, the similarity may be considered to be higher.

Alternatively, the processor 110 may extract feature points from each of the AR image and the drone image. For example, the processor 110 may extract feature points from each of the AR image and the drone image by applying at least one of Scale Invariant Feature Transform (SIFT), Speeded up robust features (SURF), and Oriented fast and rotated brief (ORB) algorithms, and may calculate a matching ratio between the extracted feature points as a similarity.

The processor 110 may compare the similarity between the AR image and the drone image with a predetermined similarity. When the similarity between the AR image and the drone image is lower than the predetermined similarity, the processor 110 may correct the second location information to match the FOV of the virtual camera with the drone image (S600).

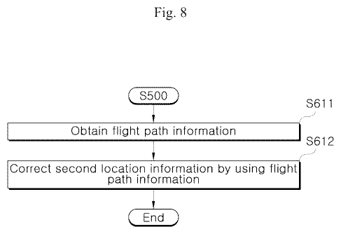

This will be described with reference to FIGS. 8 to 11.

FIGS. 8 to 11 are detailed flowcharts of operation S600 illustrated in FIG. 7.

Referring to FIG. 8, the processor 110 may obtain predetermined flight path information of the drone 200 (S611) and may correct second location information by using the flight path information (S612).

For example, the processor 110 may correct the second location information such that the drone 200 moves based on the predetermined flight information. To this end, the processor 110 may obtain the predetermined flight path information of the drone 200. The processor 110 may determine whether the second location information is included in the flight path information, and may correct the second location information by using one of location information included in the flight path information based on the determination result.

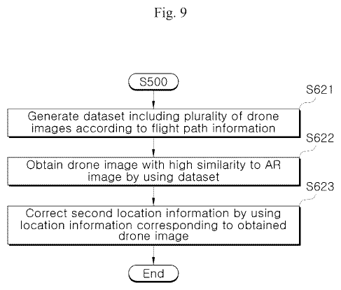

Alternatively, referring to FIG. 9, the processor 110 may generate a dataset including a plurality of drone images according to the flight path information (S621), may obtain a drone image with high similarity to an AR image by using the dataset (S622), and may correct the second location information by using location information corresponding to the obtained drone image (S623).

The processor 110 may acquire the plurality of drone images obtained by capturing a real object while the drone 200 moves based on the predetermined flight path information. The processor 110 may generate the dataset by matching the acquired plurality of drone images with location information at the time of acquisition of each drone image. For example, the dataset may be built by using location information including at least one of a latitude, a longitude, an altitude, and a rotation value as a class and using the drone image as a value.

The processor 110 may obtain the drone image with high similarity to the AR image by using the dataset. For example, the processor 110 may calculate the similarity between the plurality of drone images stored in the dataset and the AR image, and may obtain a single drone image with the highest similarity to the AR image.

The processor 110 may extract location information matching the acquired drone image from the dataset and may correct the second location information by using the extracted location information.

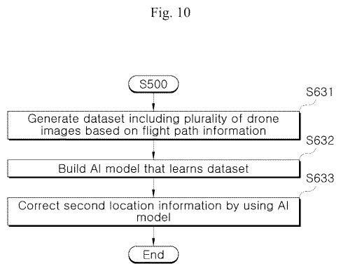

Alternatively, referring to FIG. 10, the processor 110 may generate the dataset including the plurality of drone images based on the flight path information (S631), may build an AI model that learns the dataset (S632), and may correct the second location information by using the AI model (S633).

The processor 110 may include the AI model learning the aforementioned dataset. Here, the AI model may output location information corresponding to an input image.

For example, the processor 110 may include a plurality of pre-learned artificial neural networks for performing a machine learning algorithm. Output data may be output based on input data by using machine learning, and self-learning may be performed by using the results, thereby improving data processing capabilities. An artificial neural network (ANN) may extract features based on the input data, and may infer regularities to output the output data. As these processes are accumulated, the reliability of the output data increases.

In an embodiment, the AI model may be an algorithm that outputs location information about the input image.

After performing a process of using big data as input data or removing unnecessary data, the ANN may infer optimal output data by using the input data.

According to the type of learning, AI machine learning models include Supervised Learning, Unsupervised Learning, Semisupervised Learning, and Reinforcement Learning. Moreover, Decision Tree, K-Nearest Neighbor, Artificial Neural Network, Support Vector Machine, Ensemble Learning, Gradient Descent, Na ïve Bayes Classifier, Hidden Markov Model, and K-Means Clustering may be used as machine learning algorithms.

The ANN may stack and connect numerous artificial neurons into several layers. The ANN may be pre-learned on various input values capable of being included in the input data. The ANN may infer vulnerabilities according to data entered by a user and then may output data.

The ANN may be an ANN learned depending on reinforcement learning that is a type of learning method. The reinforcement learning is a method that gradually increases the probability of obtaining a correct result by setting rewards and constraints.

The ANN may be modeled based on a Convolutional Neural Network (CNN) or a Recurrent Neural Network (RNN).

The processor 110 may input an AR image into the AI model to output location information corresponding to the AR image.

The processor 110 may correct the second location information by using location information corresponding to the output of the AI model.

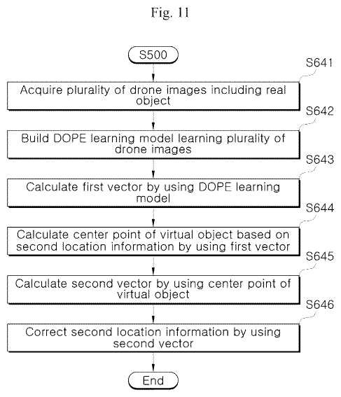

Alternatively, referring to FIG. 11, the processor 110 may acquire a plurality of drone images including a real object (S641), may build a Deep Object Pose Estimation (DOPE) learning model learning the plurality of drone images (S642), may calculate a first vector by using the DOPE learning model (S643), may calculate a center point of a virtual object based on the second location information by using the first vector (S644), may calculate a second vector by using the center point of the virtual object (S645), and may correct the second location information by using the second vector (S646).

The processor 110 may acquire the plurality of drone images obtained by capturing a real object. For example, the processor 110 may acquire the plurality of drone images that are obtained by capturing a 3D model from modeling a real object at a plurality of angles.

The processor 110 may include the DOPE learning model learning the plurality of drone images. In an embodiment, the DOPE learning model may output a vector from a camera to the center point of the real object included in the input image. The DOPE learning model may be widely used as a deep learning-based learning model that estimates the pose and location of 3D objects. For example, it may output coordinates representing the appearance of a 3D object in the 2D image and its center coordinates by using a 2D image as an input.

The processor 110 may input a drone image to the DOPE learning model and may output a first vector representing the distance from a camera mounted on the drone 200 to the center point of a real object included in the drone image.

The processor 110 may calculate the distance from the second location information to a virtual object by using the first vector to obtain the center point of the virtual object based on the second location information as the first center point coordinates. For example, the processor 110 may obtain the first center point coordinates by adding the first vector to the coordinates corresponding to the second location information.

The processor 110 may obtain the center point corresponding to the location of a predetermined virtual object in virtual space as the second center point coordinates. For example, the processor 110 may obtain the center point coordinates of the virtual object from BIM information.

The processor 110 may calculate the distance between the first center point coordinates and the second center point coordinates as the second vector, and may correct the second location information by applying the second vector to the second location information. For example, the processor 110 may correct the second location information in a method of subtracting the second vector from the second location information.

The present disclosure may overcome spatial limitations by generating and providing an AR image based on a drone image. Furthermore, the system 10 may provide a stable AR image by correcting the distance between a virtual object and a virtual camera in virtual space in real time.

Effects of the present disclosure are not limited to the effects mentioned above, and other effects not mentioned will be apparent by those skilled in the art from the following description.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A device for providing an AR image through merging a drone image and a virtual object in real time, the device comprising:
a communication module configured to receive the drone image from a drone; and
a processor configured to generate an augmented reality (AR) image by merging the virtual object in virtual space with the drone image,
wherein the processor is configured to:
convert first location information of the drone in real space into second location information in the virtual space;
generate the AR image based on a field of view (FOV) of a virtual camera positioned at a location corresponding to the second location information in the virtual space;
calculate a similarity between the AR image and the drone image; and
correct the second location information when the calculated similarity is lower than a predetermined similarity.

2. The device of claim 1, wherein the processor is configured to:
obtain predetermined flight path information of the drone; and
correct the second location information by using the flight path information.

3. The device of claim 2, wherein the processor is configured to:
generate a dataset including a plurality of drone images captured while the drone flies based on the flight path information;
extract a drone image, which has a highest similarity to the AR image, from among the plurality of drone images included in the dataset; and
correct the second location information by using location information corresponding to a location where the extracted drone image is captured.

4. The device of claim 3, wherein the processor is configured to:
include an Artificial intelligence (AI) model that learns the dataset and outputs location information corresponding to an input image;
obtain an output value by inputting the AR image to the AI model; and
correct the second location information by using the output value of the AI model.

5. The device of claim 4, wherein the location information includes at least one of a latitude, a longitude, an altitude, and a rotation value.

6. The device of claim 1, wherein the processor is configured to:
generate the AR image by synthesizing the virtual object with a real object in the real space, which is included in the drone image.

7. The device of claim 6, wherein the processor is configured to:
include a Deep Object Pose Estimation (DOPE) learning model that learns a plurality of images, which are obtained by capturing the real object, and outputs a vector from a camera to a center point of the real object included in an input image;
calculate the vector from the camera mounted on the drone to the center point of the real object included in the drone image by inputting the drone image to the DOPE learning model; and
correct the second location information by using the calculated vector.

8. The device of claim 7, wherein the processor is configured to:
calculate a first center point by applying the calculated vector to the second location information;
calculate a predetermined second center point to place the virtual object in the virtual space; and
correct the second location information by using a difference between the first center point and the second center point.

9. The device of claim 1, wherein the processor is configured to:
calculate the similarity by comparing a pixel value of the AR image and a pixel value of the drone image; or
extract at least one feature point from each of the AR image and the drone image, and calculate the similarity by comparing the extracted feature point.

10. An AR image providing method performed by an AR image providing device, the method comprising:
receiving a drone image from a drone;
converting first location information of the drone in real space into second location information in virtual space;
placing a virtual camera at a location corresponding to the second location information in the virtual space;
generating an AR image obtained by merging a virtual object in the virtual space with the drone image based on a FOV of the virtual camera;
calculating a similarity between the AR image and the drone image; and
correcting the second location information when the calculated similarity is lower than a predetermined similarity.
